(19) United States
(12) Patent Application Publication
(10) Pub. No.: US 2019/0344541 A1
(43) Pub. Date: Nov. 14, 2019

(54) PACKAGING MATERIAL AND METHOD OF PRODUCING SAME

(71) Applicant: SHOWA DENKO PACKAGING CO., LTD., Kanagawa (JP)

(72) Inventors: Wei HE, Kanagawa (JP); Terutoshi KUMAKI, Kanagawa (JP); Takashi NAGAOKA, Kanagawa (JP); Makoto KARATSU, Kanagawa (JP)

(73) Assignee: SHOWA DENKO PACKAGING CO., LTD., Kanagawa (JP)

(21) Appl. No.: 16/337,605

(22) PCT Filed: Jul. 3, 2017
(86) PCT No.: PCT/JP2017/024369

§ 371 Date: Mar. 28, 2019

(30) Foreign Application Priority Data
Sep. 29, 2016 (JP) 2016-191343

(51) Int. Cl. B32B 15/088; B32B 27/34; B32B 15/20; B32B 7/12; B32B 27/32; B32B 15/085; B32B 37/24; H01M 2/02

(52) U.S. Cl. CPC B32B 15/088; H01G 11/78; B32B 15/20; B32B 7/12; B32B 27/32; B32B 15/085; B32B 37/24; H01M 2/0287; H01M 2/0285; H01M 2/0277; B32B 2255/06; B32B 2255/26; B32B 2457/10; B32B 2457/16; B32B 2037/243; B32B 2311/00; B32B 2323/10; B32B 2377/00; B32B 27/34

(57) ABSTRACT

A packaging material shortens the lead time, improves productivity, and also secures excellent formability. The packaging material includes a base layer as an outer layer, a heat fusible resin layer as an inner layer, and a metal foil layer arranged between both the layers. The base layer and the metal foil layer are bonded via an outer adhesive layer composed of a cured film of a first electron beam curable resin composition containing an electron beam polymerization initiator. The heat fusible resin layer and the metal foil layer are bonded via an inner adhesive layer composed of a cured film of a second electron beam curable resin composition containing an electron beam polymerization initiator. The content rate of the electron beam polymerization initiator in each of the first electron beam curable resin composition and the second electron beam curable resin composition is 0.1 mass % to 10 mass %.

### TECHNICAL FIELD

The present invention relates to an exterior material (i.e., packaging material) for a power storage device, such as, e.g., a battery and a capacitor used for mobile electric devices exemplified by smartphones and tablet computers, and a battery and a capacitor used for hybrid vehicles, electric vehicles, wind power generation, solar power generation, and nighttime electricity storage. The present invention also relates to a packaging material used for, e.g., a packaging material for foods and a packaging material for pharmaceutical products and a production method thereof.

### BACKGROUND ART

A lithium ion secondary battery has been widely used as a power source for laptop computers, video cameras, mobile phones, electric vehicles, and the like. As this lithium ion secondary battery, a lithium ion secondary battery having a configuration in which a battery main body (a main body including a positive electrode, a negative electrode, and an electrolyte) is surrounded by a case has been used. As a material (packaging material) for this case, there is known a packaging material having a configuration in which an outer layer formed of a heat resistant resin film, an aluminum foil layer, and an inner layer formed of a thermoplastic resin film are integrally bonded in this order.

For example, there is known a packaging material for a battery having a base layer (outer layer), a first adhesive layer, a metal foil layer, a second adhesive layer, and a sealant layer (inner layer) laminated in this order and having a configuration in which the first adhesive layer and the second adhesive layer are formed by heat curing (heat aging) (see Patent Document 1).

### PRIOR ART

Patent Document
Patent Document 1: Japanese Unexamined Patent Application Publication No. 2015-144122

### SUMMARY OF THE INVENTION

### Problems to be Solved by the Invention

In order to form the first and second adhesive layers by the aforementioned heat curing, it is necessary to perform a heat aging treatment at 40° C. for 5 days or 10 days after the application of an adhesive agent (see paragraph [0097] of Patent Document 1).

As described above, the heat aging treatment must be performed for at least 5 days or more. For this reason, there was a problem that the lead time (the time required from the material input to the product completion) was considerably long, i.e., it was inferior to productivity.

The present invention has been made in view of the aforementioned technical background, and aims to provide a packaging material capable of significantly shortening the lead time and improving the productivity, and also ensuring excellent formability, and a method of producing the same.

### Means for Solving the Problems

In order to attain the aforementioned object, the present invention provides the following means.

[1] A packaging material for a power storage device, comprising:

a base layer as an outer layer;

a heat fusible resin layer as an inner layer; and

a metal foil layer arranged between the base layer and the heat fusible resin layer,

wherein the base layer and the metal foil layer are bonded via an outer adhesive layer composed of a cured film of a first electron beam curable resin composition containing an electron beam polymerization initiator,

wherein the heat fusible rein layer and the metal foil layer are bonded via an inner adhesive layer composed of a cured film of a second electron beam curable resin composition containing an electron beam polymerization initiator,

wherein a content rate of the electron beam polymerization initiator in the first electron beam curable resin composition is 0.1 mass % to 10 mass %, and

wherein a content rate of the electron beam polymerization initiator in the second electron beam curable resin composition is 0.1 mass % to 10 mass %.

[2] The packaging material as recited in the aforementioned Item [1],

wherein the first electron beam curable resin composition and the second electron beam curable resin composition each are a composition containing a polymerizable oligomer and a polymerizable monomer together with the electron beam polymerization initiator, and

wherein the content rate of the polymerizable monomer in each of the first electron beam curable resin composition and the second electron beam curable resin composition is 0.01 mass % to 5 mass %.

[3] The packaging material as recited in the aforementioned Item [1] or [2],

wherein the second electron beam curable resin composition has the same composition as the first electron beam curable resin composition.

[4] The packaging material as recited in any one of the aforementioned Items [1] to [3],

wherein the base layer is composed of a heat resistant resin film having a hot water shrinkage percentage of 1.5% to 12%.

[5] A packaging material comprising:

a base layer as an outer layer;

a heat fusible resin layer as an inner layer; and

a metal foil layer arranged between the base layer and the heat fusible resin layer,

wherein the base layer is composed of a cured film of a third electron beam curable resin composition containing an electron beam polymerization initiator,

wherein the heat fusible rein layer and the metal foil layer are bonded via an inner adhesive layer composed of a cured film of a second electron beam curable resin composition containing an electron beam polymerization initiator,

wherein a content rate of the electron beam polymerization initiator in the second electron beam curable resin composition is 0.1 mass % to 10 mass %, and

wherein a content rate of the electron beam polymerization initiator in the third electron beam curable resin composition is 0.1 mass % to 10 mass %.

[6] The packaging material as recited in the aforementioned Item [5],

wherein the third electron beam curable resin composition is the same composition as the second electron beam curable resin composition.

[7] A method of producing a packaging material, comprising:

a step of preparing a first laminate in which a resin film for a base layer is bonded to one surface of a metal foil layer via a first electron beam curable resin composition and then irradiating the first laminate with an electron beam from a side of the resin film for a base layer; and

a step of preparing a second laminate in which a heat fusible resin film is bonded to the other surface of the metal foil layer of the first laminate after irradiation of the electron beam via a second electron beam curable resin composition and then irradiating the second laminate with an electron beam from a side of the heat fusible resin film.

[8] A method of producing a packaging material, comprising:

a step of preparing a first laminate in which a heat fusible resin film is bonded to one surface of a metal foil layer via a second electron beam curable resin composition and then irradiating the first laminate with an electron beam from a side of the heat fusible resin film; and a step of preparing a second laminate in which a resin film for a base layer is bonded to the other surface of the metal foil layer of the first laminate after irradiation of the electron beam via a first electron beam curable resin composition and then irradiating the second laminate with an electron beam from a side of the resin film for a base layer.

[9] A method of producing a packaging material, comprising:

a step of preparing a laminate in which a resin film for a base layer is bonded to one surface of a metal foil layer via a first electron beam curable resin composition and a heat fusible resin film is bonded to the other surface of the metal foil layer via a second electron beam curable resin composition; and a step of irradiating both surfaces of the laminate with an electron beam.

[10] A method of producing a packaging material, comprising:

a step of preparing a first laminate in which a heat fusible resin film is bonded to one surface of a metal foil layer via a second electron beam curable resin composition and then irradiating the first laminate with an electron beam from a side of the heat fusible resin film; and

a step of obtaining a second laminate by applying a third electron beam curable resin composition on the other surface of a metal foil layer of a first laminate after irradiation of the electron beam, and then irradiating the second laminate with an electron beam from a side of the third electron beam curable resin composition.

[11] A method of producing a packaging material, comprising:

a step of obtaining a first laminate by applying a third electron beam curable resin composition on one surface of a metal foil layer, and then irradiating the first laminate with an electron beam from a side of the third electron beam curable resin composition; and

a step of preparing a second laminate in which a heat fusible resin film is bonded to the other surface of the metal foil layer of the first laminate after irradiation of the electron beam via a second electron beam curable resin composition and then irradiating the second laminate with an electron beam from a side of the heat fusible resin film.

[12] A method of producing a packaging material, comprising:

a step of preparing a first laminate in which a heat fusible resin film is bonded to one surface of a metal foil layer via a second electron beam curable resin composition;

a step of obtaining a second laminate by applying a third electron beam curable resin composition to the other surface of the metal foil layer in the first laminate; and

a step of irradiating both surfaces of the second laminate with an electron beam.

### Effects of the Invention

In the invention as recited in the aforementioned Item [1], it is configured such that the base layer and the metal foil layer are bonded via the outer adhesive layer made of the cured film containing the first electron beam curable resin composition and the heat fusible resin layer and the metal foil layer are bonded via the inner adhesive layer made of a cured film containing the second electron beam curable resin composition. The electron beam curing (e.g., light curing) of the electron beam curable resin composition can be carried out in a much shorter time as compared with curing of a thermosetting resin which requires heat aging for several days (it is not required to perform a heat aging process for several days). Therefore, the lead time (time required from the material input to the product completion) can be drastically shortened, which in turn can attain the cost reduction. Further, the content rate of the electron beam polymerization initiator in each of the first and second electron beam curable resin compositions is 0.1 mass % to 10 mass %. Therefore, the polymerization reactivity can be further improved, which in turn can further shorten the lead time. Furthermore, even if forming with a deep forming depth is performed by cold (normal temperature) forming, such as, e.g., deep-drawing forming and stretch forming, neither pinholes nor cracks are generated, ensuring excellent formability. Furthermore, in the packaging material of the present invention, regardless of which one of the lamination of the “lamination of the heat fusible resin layer and the metal foil layer” and the “lamination of the base layer and the metal foil layer” is performed at the time of the production, a packaging material having the same characteristics and the same quality can be obtained. Therefore, there is also an advantage that the degree of freedom of the production method is high.

In the invention as recited in the aforementioned Item [2], it is configured such that the content rate of the polymerizable monomer in each of the first electron beam curable resin composition and the second electron beam curable resin composition is 0.01 mass % to 5 mass %. Therefore, it is possible to secure even greater lamination strength.

In the invention as recited in the aforementioned Item [3], the second electron beam curable resin composition has the same composition (the same composition; the content rate is also the same) as the first electron beam curable resin composition. Therefore, at the time of the production, it is unnecessary to perform the replacement work of the adhesive agent in the adhesive agent reservoir (replacing the inner adhesive agent with the outer adhesive agent or replacing the outer adhesive agent with the inner adhesive agent), which improves the productivity.

In the invention as recited in the aforementioned Item [4], it is configured such that the base layer is composed of a heat resistant resin film having a hot water shrinkage percentage of 1.5% to 12%. Even if forming with a deep forming depth is performed or even if it is used under severe environments such as high temperature and high humidity, delamination (separation) between the outer layer (base layer) and the metal foil layer can be sufficiently prevented.

In the invention as recited in the aforementioned Item [5], it is configured such that the base layer is composed of a cured film of a third electron beam curable resin composition containing an electron beam polymerization initiator and the heat fusible resin layer and the metal foil layer are bonded via an inner adhesive layer composed of a cured film of a second electron beam curable resin composition. Furthermore, the electron beam curing (such as light curing) of the electron beam curable resin composition can be performed in a shorter time compared with curing of a thermosetting resin which requires several days for heat aging. Therefore, there is also an advantage that the lead time (the time required from the material input to the product completion) can be drastically shortened, which in turn can attain the cost reduction. Further, the content rate of the electron beam polymerization initiator in the second and third electron beam curable resin compositions is 0.1 mass % to 10 mass o, and therefore the polymerization reactivity can be further improved, which in turn can further shorten the lead time. Furthermore, abase layer composed of a cured film of the third electron beam curable resin composition is provided outside the metal foil layer. Therefore, even if forming with a deep forming depth is performed by cold (normal temperature) forming, such as, e.g., deep-drawing forming and stretch forming, no pinholes and cracks are generated, which can secure excellent formability.

In the invention recited in the aforementioned Item [6], the third electron beam curable resin composition has the same composition (the same composition; the content rate is also the same) as the second electron beam curable resin composition. Therefore, at the time of the production, it becomes unnecessary to perform the replacement work of the electron beam curable resin composition in the adhesive agent tank (container) (replacing the second electron beam curable resin composition for the inner adhesive agent with the third electron beam curable resin composition for the base layer or replacing the third electron beam curable resin composition for the base layer with the second electron beam curable resin composition for the inner adhesive agent), which in turn can improve the productivity.

In the invention as recited in the aforementioned Items [7] to [9], bonding (curing) by the adhesive layer is performed by irradiation of the electron beam, and such electron beam curing (light curing, etc.) can be performed in a shorter time as compared with the curing of the thermosetting resin requiring heat aging for several days. Therefore, the lead time (time required from the material input to the product completion) can be drastically shortened, which in turn can attain the cost reduction. Even if forming with a deep forming depth is performed for the obtained packaging material by cold (normal temperature) forming, such as, e.g., deep-drawing forming and stretch forming, neither pinholes nor cracks are generated, which in turn can secure excellent formability.

In the invention as recited in the aforementioned Item [9], simultaneous curing of the two layers (the outer adhesive layer and the inner adhesive layer) can be carried out by simultaneously irradiating both surfaces of the laminate with an electron beam. Therefore, the lead time can be further shortened (the productivity can be further improved).

In the invention as recited in the aforementioned Items [10] to [12], formation of the base layer and bonding (curing) by the inner adhesive layer are carried out by irradiation of the electron beam. Such electron beam curing (light curing, etc.) can be performed in a shorter time as compared with curing of a thermosetting resin requiring heat aging for several days. Therefore, the lead time (the time required from the material input to the product completion) can be drastically shortened, which in turn can attain the cost reduction. Even if forming with a deep forming depth is carried out by cold (normal temperature) forming, such as, e.g., deep-drawing forming and stretch forming, for the obtained packaging material, neither pinholes nor cracks are generated, which can secure excellent formability.

According to the invention as recited in the aforementioned Item [12], simultaneous curing of the two layers (the base layer and the inner adhesive layer) can be carried out by simultaneously irradiating both surfaces of the laminate with an electron beam. Therefore, the lead time can be further shortened (the productivity can be further improved).

### BRIEF DESCRIPTION OF THE DRAWINGS

FIG. 1 is a cross-sectional view showing one embodiment of a packaging material according to a first invention.

FIG. 2 is a cross-sectional view showing one embodiment of a packaging material according to a second invention.

FIG. 3 is a cross-sectional view showing one embodiment of a power storage device according to the present invention.

FIG. 4 is a perspective view showing a packaging material (planar shape), a power storage device main body, and a shaped case (three-dimensionally formed product) constituting the power storage device of FIG. 3 in a state before heat-sealing them.

### EMBODIMENTS FOR CARRYING OUT THE INVENTION

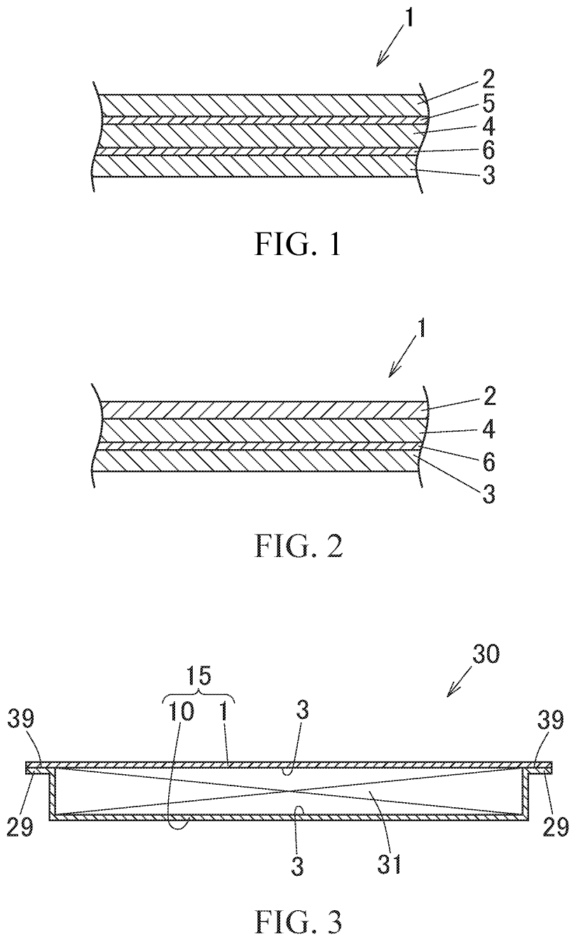

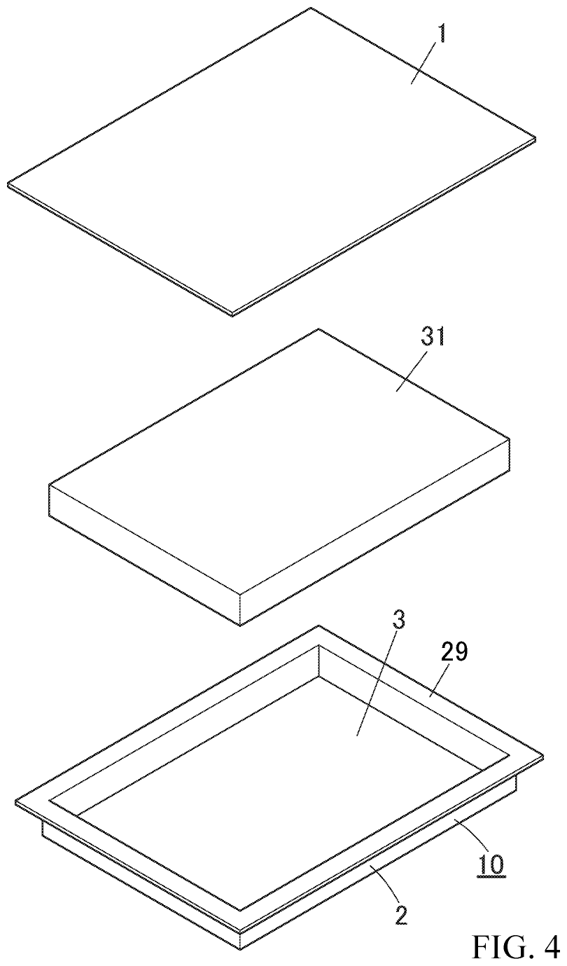

FIG. 1 shows an embodiment of a packaging material 1 according to the first aspect of the present invention. This packaging material 1 is used as a packaging material for a battery, such as, e.g., lithium ion secondary batteries. The packaging material 1 may be used as a packaging material 1 as it is without being subjected to forming (see FIG. 4) or may be used as a shaped case 10 by being subjected to forming, such as, e.g., deep-drawing forming and stretch forming (see FIG. 4).

The packaging material 1 for a power storage device is configured such that a base layer (outer layer) 2 is integrally laminated on one surface (upper surface) of a metal foil layer 4 via an outer adhesive layer (first adhesive layer) 5 and a heat fusible resin layer (inner layer) 3 is integrally laminated on the other surface (lower surface) of the metal foil layer 4 via an inner adhesive layer (second adhesive layer) 6 (see FIG. 1).

An embodiment of a packaging material 1 according to the second invention is shown in FIG. 2. This packaging material 1 is used as a packaging material for a battery, such as, e.g., lithium ion secondary batteries. The packaging material 1 may be used as a packaging material 1 as it is without being subjected to forming (see FIG. 4) or may be used as a shaped case 10 by being subjected to forming, such as, e.g., deep-drawing forming and stretch forming (see FIG. 4).

The packaging material 1 shown in FIG. 2 is configured such that a base layer (outer layer) 2 composed of a cured film of a third electron beam curable resin composition is integrally laminated on one surface (upper surface) of the metal foil layer 4 and a heat fusible resin layer (inner layer) 3 is integrally laminated on the other surface (lower surface) of the metal foil layer 4 via an inner adhesive layer (second adhesive layer) 6 composed of a cured film of a second electron beam curable resin composition (see FIG. 2).

In the first and second inventions, the base layer (outer layer) 2 is a member mainly playing a role of ensuring good formability as the packaging material 1, that is, it mainly plays a role of preventing breakage due to necking of the aluminum foil at the time of forming.

In the first invention, the base layer 2 is preferably formed of a heat resistant resin layer. As the heat resistant resin constituting the heat resistant resin layer 2, a heat resistant resin which does not melt at the heat sealing temperature when heat sealing the packaging material 1 is used. As the heat resistant resin, it is preferable to use a heat resistant resin having a melting point higher than the melting point of the heat fusible resin constituting the heat fusible resin layer 3 by 10° C. or more, and particularly preferable to use a heat resistant resin having a melting point higher than the melting point of the heat fusible resin by 20° C. or more.

The heat resistant resin layer (outer layer) 2 is not particularly limited, and examples thereof include a stretched polyamide film such as a stretched nylon film, a stretched polyester film and the like. Among them, as the heat resistant resin layer 2, it is preferable to use a biaxially stretched polyamide film such as a biaxially stretched nylon film, a biaxially stretched polybutylene terephthalate (PBT) film, a biaxially stretched polyethylene terephthalate (PET) film or a biaxially stretched polyethylene naphthalate (PEN) film. Further, as the heat resistant resin stretched film 2, it is preferable to use a heat resistant resin biaxially stretched film stretched by a simultaneous biaxial stretching method. The nylon film is not particularly limited, but is exemplified by a 6 nylon film, a 6, 6 nylon film, an MXD nylon film, and the like. The heat resistant resin film layer 2 may be formed of a single layer (single stretched film) or may be made of multiple layers (e.g., multiple layers composed of a stretched PET film/a stretched nylon film) composed of, for example, a stretched polyester film/a stretched polyamide film.

In the first invention, the heat resistant resin layer 2 is preferably configured by a heat resistant resin film having a hot water shrinkage percentage of 1.5% to 12%. When the hot water shrinkage percentage is 1.5% or more, occurrence of breaks and cracks during the forming work can be further prevented. When the hot water shrinkage percentage is 12% or less, occurrence of delamination (separation) between the outer layer 2 and the metal foil layer 4 can be further prevented. In particular, as the heat resistant resin film, it is preferable to use a heat resistant resin film having a hot water shrinkage percentage of 1.8% to 11%. Furthermore, it is more preferable to use a heat resistant resin film having a hot water shrinkage percentage of 1.8% to 6%. As the heat resistant resin film, it is preferable to use a heat resistant resin stretched film.

The “hot water shrinkage percentage” is a dimensional change rate of a test piece (10 cm×10 cm) of a heat resistant resin stretched film 2 in the stretching direction before and after immersion of the test piece in 95° C. hot water for 30 minutes, and can be obtained by the following equation.

Hot water shrinkage percentage (%)={(X−Y)/X}×100

X: Dimension in the stretching direction before immersion treatment

Y: Dimension in the stretching direction after the immersion treatment

Note that the hot water shrinkage percentage in the case of adopting a biaxially stretched film is an average value of the dimensional change rates in the two stretching directions.

The hot water shrinkage percentage of the heat resistant resin stretched film can be controlled by, for example, adjusting the heat setting temperature at the time of stretching processing.

In the first and second inventions, the thickness of the base layer 2 is preferably 12 μm to 50 μm. By setting the thickness to a value equal to or larger than the aforementioned preferred lower limit value, it is possible to ensure sufficient strength as a packaging material. By setting the thickness to a value equal to or smaller than the aforementioned preferred upper limit, it is possible to reduce the stress at the time of stretch forming or drawing forming, thereby improving the formability.

In the first invention, the outer adhesive layer (first adhesive layer) 5 is formed of an adhesive layer composed of a cured film of a first electron beam curable resin composition. In the second invention, the base layer 2 is composed of a cured film of a third electron beam curable resin composition. Further, in the first and second inventions, the inner adhesive layer (second adhesive layer) 6 is formed of an adhesive layer composed of a cured film of a second electron beam curable resin composition. The cured film of the first to third electron beam curable resin compositions is not particularly limited as long as it has insulating properties.

The first electron beam curable resin composition, the second electron beam curable resin composition, and the third electron beam curable resin composition each are a composition containing a polymerizable oligomer and an electron beam polymerization initiator. Among them, a composition containing a polymerizable oligomer, a polymerizable monomer, and an electron beam polymerization initiator is preferable. Each of the first to third electron beam curable resin compositions may be a radical polymerization based resin composition, may be a cationic polymerization based resin composition, and may be a radical polymerization and cationic polymerization based resin composition (a mixture of a radical polymerization based resin composition and a cationic polymerization based resin composition), but not particularly limited thereto. The first to third electron beam curable resin compositions each are preferably an acrylic based ultraviolet curable resin composition.

The first electron beam curable resin composition, the second electron beam curable resin composition, and the third electron beam curable resin composition are required, in each composition, that the content rate of the electron beam polymerization initiator are set to 0.1 mass % to 10 mass %. When the content is less than 0.1 mass %, the polymerization reaction slows down, resulting in a decreased productivity. When the content exceeds 10 mass %, the adhesive component becomes relatively small, resulting in decreased lamination strength. Among them, the first electron beam curable resin composition, the second electron beam curable resin composition, and the third electron beam curable resin composition are preferred, in each composition, that the content rate of the electron beam polymerization initiator are 0.5 mass % to 7 mass %.

The polymerizable oligomer is not particularly limited, but is exemplified by a radical polymerization type oligomer, such as, e.g., a urethane acrylate oligomer, and epoxy acrylate oligomer, and a polyester acrylate oligomer, and a cationic polymerization type oligomer, such as, e.g., a vinyl ether oligomer and an alicyclic type epoxy oligomer.

The electron beam polymerization initiator is not particularly limited, but may be exemplified by a photo-radical polymerization initiator and a photo-cationic polymerization initiator. The photo-radical polymerization initiator is not particularly limited, but is exemplified by benzophenone, benzoin alkyl ether (benzoethyl ether, benzobutyl ether, etc.), and benzyl dimethyl ketal.

The photo-cationic polymerization initiator is not particularly limited, but is exemplified by onium salt. The onium salt is not particularly limited, but exemplified by a sulfonium salt, an iodonium salt, a bromonium salt, a diazonium salt, and a chloronium salt.

The sulfonium salt is not particularly limited, but is exemplified by triphenylsulfonium hexafluorophosphate, triphenylsulfonium hexafluoroantimonate, triphenylsulfonium tetrakis (pentafluorophenyl) borate, 4,4′-bis [diphenylsulfonio] diphenylsulfide-bishexafluorophosphate, 4,4′-bis [di(β-hydroxyethoxy) phenylsulfonio] diphenylsulfide-bishexafluoroantimonate, 4,4′-bis[di (β-hydroxyethoxy) phenylsulfonio] diphenylsulfide-bishexafluorophosphate, 7-[di(p-toluyl) sulfonio]-2-isopropylthioxanthone hexafluoroantimonate, 7-[di (p-toluyl) sulfonio]-2-isopropylthioxanthone tetrakis (pentafluorophenyl) borate, 4-phenylcarbonyl-4′-diphenylsulfonio-diphenyl sulfide-hexafluorophosphate, 4-(p-ter-butylphenylcarbonyl)-4′-diphenylsulfonio-diphenyl sulfide-hexafluoroantimonate, 4-(p-ter-butylphenylcarbonyl)-4′-di(p-toluyl) sulfonio-diphenyl sulfide-tetrakis (pentafluorophenyl) borate, and triphenylsulfonium bromide.

The iodonium salt is not particularly limited, but is exemplified by diphenyliodonium tetrakis (pentafluorophenyl) borate, diphenyliodonium hexafluorophosphate, diphenyliodonium hexafluoroantimonate, and di(4-nonylphenyl) iodonium hexafluoro phosphate.

Further, the polymerizable monomer is not particularly limited, but is exemplified by (meth) acrylate and vinyl ether.

The (meth) acrylate is not particularly limited, but is exemplified by pentaerythritol triacrylate, neopentyl glycol diacrylate, and phosphoric acid-containing (meth) acrylate. The phosphoric acid-containing (meth) acrylate (monomer) is not particularly limited, but is exemplified by monomers, such as, e.g., acryloyloxyethyl acid phosphate and bis (2-(meth) acryloyloxyethyl) acid phosphate.

The vinyl ether is not particularly limited, but is exemplified by 2-hydroxyethyl vinyl ether (HEVE), diethylene glycol monovinyl ether (DEGV), and 4-hydroxybutyl vinyl ether (HBVE).

The electron beam curable resin composition may contain a silane coupling agent, an acid anhydride, a sensitizer, various additives, and the like.

The silane coupling agent is not particularly limited, but is exemplified by methyltrimethoxysilane, vinyltrimethoxysilane, vinyltriethoxysilane, allyltrimethoxysilane, 3-(methacryloyloxy) propyltrimethoxysilane, and the like. Among them, as the silane coupling agent, a silane coupling agent having a carbon-carbon double bond, such as, e.g., vinyl triethoxysilane and allyl trimethoxysilane is preferably used. In this case, it is possible to strengthen the bonding with an adhesive agent which utilizes a radical polymerization reaction, in particular.

The acid anhydride is not particularly limited, but is exemplified by maleic anhydride, methyl maleic anhydride, itaconic anhydride, himic anhydride, and methyl himic anhydride. Among them, as the acid anhydride, it is preferable to use acid anhydride having a carbon-carbon double bond such as maleic anhydride, and the radical polymerization reaction can be further promoted by the acid anhydride having such a double bond.

The sensitizer is not particularly limited, but is exemplified by tertiary amine. The tertiary amine is not particularly limited, but is exemplified by N, N-dimethylethylamine, N, N-dimethylethanolamine, and N, N, 3,5-tetramethylaniline.

In the first invention, it is preferable that the thickness (thickness after drying) of the outer adhesive layer (first adhesive layer) 5 be set to 1 μm to 6 μm.

In the first and second inventions, the metal foil layer 4 plays a role of imparting a gas barrier property that prevents invasion of oxygen and moisture into the packaging material 1. The metal foil layer 4 is not particularly limited, but is exemplified by an aluminum foil, a copper foil, a SUS foil (stainless steel foil), and a nickel foil, and an aluminum foil is generally used. The thickness of the metal foil layer 4 is preferably 9 μm to 120 μm. When the thickness is 9 μm or more, it is possible to prevent generation of pinholes at the time of rolling when producing a metal foil, and when the thickness is 120 μm or less, it is possible to reduce the stress at the time of forming, such as, e.g., stretch forming and drawing, thereby improving the formability. Especially, the thickness of the metal foil layer 4 is particularly preferably 20 μm to 100 μm.

It is preferable that the metal foil layer 4 be subjected to a chemical conversion treatment at least on the inner surface (the surface on the inner adhesive layer 6 side). When such chemical conversion treatment is subjected, corrosion of the surface of the metal foil due to contents (electrolyte, etc., of a battery) can be prevented sufficiently. For example, the chemical treatment is applied to the metal foil by performing the following treatment. That is, for example, a chemical conversion treatment is performed by coating one of the following aqueous solutions 1) to 3) on the surface of the metal foil subjected to a degreasing treatment, followed by drying.

1) an aqueous solution of a mixture containing:

phosphoric acid;

chromic acid;

at least one compound selected from the group consisting of a metal salt of a fluoride and a nonmetal salt of a fluoride

2) an aqueous solution of a mixture containing:

phosphoric acid;

at least one resin selected from the group consisting of an acryl based resin, a chitosan derivative resin, and a phenol based resin; and

at least one compound selected from the group consisting of a chromic acid and a chromium (III) salt

3) an aqueous solution of a mixture containing:

phosphoric acid;

at least one resin selected from the group consisting of an acryl based resin, a chitosan derivative resin, and a phenol based resin;

at least one compound selected from the group consisting of a chromic acid and a chromium (III) salt; and

at least one compound selected from the group consisting of a metal salt of a fluoride and a non-metal salt of a fluoride.

The chemical conversion coating film is preferably 0.1 mg/m² to 50 mg/m² as a chromium adhesion amount (per one side), especially preferably 2 mg/m² to 20 mg/m².

In the first and second inventions, the heat fusible resin layer (inner layer) 3 plays a role of imparting excellent chemical resistance also against a highly corrosive electrolyte used in a lithium ion secondary battery and the like and also imparting a heat sealing property to the packaging material.

The resin constituting the heat fusible resin layer 3 is not particularly limited, but examples thereof include polyethylene, polypropylene, ionomer, ethylene ethyl acrylate (EEA), ethylene methyl acrylate (EAA), ethylene methyl methacrylate resin (EMMA), ethylene-vinyl acetate copolymer resin (EVA), maleic anhydride modified polypropylene, maleic anhydride modified polyethylene, and a polyester resin.

The thickness of the heat fusible resin layer 3 is preferably set to 15 μm to 100 μm. Setting the thickness to 15 μm or more enables securing of sufficient heat seal strength, and setting the thickness to 100 μm or less contributes to thinning and weight reduction. In particular, the thickness of the heat fusible resin layer 3 is particularly preferably set to 20 μm to 40 μm. The heat fusible resin layer 3 is preferably formed of a heat fusible resin non-stretched film layer, and the heat fusible resin layer 3 may be a single layer or multiple layers.

By shaping (deep-drawing forming, stretch forming, etc.) the packaging material 1 according to the first or second invention, a packaging case (packaging case for a power storage device) 10 can be obtained. Note that the packaging material 1 of the first and second inventions can be used as it is without being subjected to shaping (see FIG. 4).

FIG. 3 shows one embodiment of a power storage device 30 configured by using the packaging material 1 of the first and second inventions. This power storage device 30 is a lithium ion secondary battery. In this embodiment, as shown in FIG. 3 and FIG. 4, a packaging member 15 is constituted by a case 10 obtained by shaping the packaging material 1 and a planar packaging material 1 not subjected to shaping. The power storage device 30 of the present invention is constituted (see FIG. 3 and FIG. 4) by accommodating a substantially rectangular parallelepiped power storage device main body (electrochemical element or the like) 31 in an accommodation recess of a shaped case 10 obtained by shaping the packaging material 1 of the first and second inventions, arranging a packaging material 1 of the first or second invention on the power storage device main body 31 without being shaped with its inner layer 3 side facing inward (lower side), and heat-sealing the peripheral portion of the inner layer 3 of the planar packaging material 1 and the inner layer 3 of the flange portion (sealing peripheral portion) 29 of the shaped case 10 to be heat-sealed. The inner side surface of the accommodation recess of the shaped case 10 is an inner layer (heat fusible resin layer) 3, and the outer surface of the accommodation recess is an outer layer (base layer) 2 (see FIG. 4).

In FIG. 3, the reference numeral “39” denotes a heat sealed portion in which the peripheral portion of the packaging material 1 and the flange portion (sealing peripheral portion) 29 of the shaped case 10 are joined (heat-sealed). In the power storage device 30, the tip end portion of a tab lead connected to the power storage device main body portion 31 is led to the outside of the packaging member 15, but the illustration is omitted.

Although not particularly limited, the power storage device main body 31 is exemplified by, for example, a battery main body portion, a capacitor main body portion, and an electrical condenser main body portion.

It is preferable that the width of the heat seal portion 39 be set to 0.5 mm or more. When it is set to 0.5 mm or more, sealing can be reliably performed. In particular, it is preferable that the width of the heat seal portion 39 be set to 3 mm to 15 mm.

In the above embodiment, the packaging member 15 is composed of the shaped case 10 obtained by shaping the packaging material 1 and the planar packaging material 1 (see FIG. 3 and FIG. 4). However, the present invention is not particularly limited to such a combination. For example, the packaging member 15 may have a configuration composed of a pair of packaging materials 1, or may have a configuration composed of a pair of packaging cases 10.

Next, a preferred example of the production method of the packaging material according to the first invention will be described. The following first to third production methods can be exemplified.

(First Production Method)

The first production method includes:

a step of creating a first laminate in which a resin film for a base layer (heat resistant resin film, etc.) 2 is bonded to one surface of a metal foil layer 4 via a first electron beam curable resin composition and then irradiating the first laminate with an electron beam from a side of the resin film for a base layer (heat resistant resin film, etc.); and

a step of preparing a second laminate in which a heat fusible resin film 3 is bonded to the other surface of the metal foil layer of the first laminate after irradiation of the electron beam via a second electron beam curable resin composition and then irradiating the second laminate with an electron beam from a side of the heat fusible resin film.

(Second Production Method)

The second production method includes:

a step of creating a first laminate in which a heat fusible resin film 3 is bonded to one surface of a metal foil layer 4 via a second electron beam curable resin composition and then irradiating the first laminate with an electron beam from a side of the heat fusible resin film; and

a step of creating a second laminate in which a resin film for a base layer (heat resistant resin film, etc.) 2 is bonded to the other surface of the metal foil layer 4 via a first electron beam curable resin composition after irradiation of the electron beam and then irradiating the second laminate with an electron beam from a side of the resin film for abase layer (heat resistant resin film, etc.).

(Third Production Method)

The third production method includes:

a step of creating a laminate in which a resin film for a base layer (heat resistant resin film, etc.) 2 is bonded to one surface of the metal foil layer 4 via a first electron beam curable resin composition and a heat fusible resin film 3 is bonded to the other surface of the metal foil layer 4 via a second electron beam curable resin composition; and

a step of irradiating both surfaces of the laminate with an electron beam.

Among these first to third production methods, in the third production method, simultaneous curing of the two layers (the outer adhesive layer and the inner adhesive layer) can be carried out by simultaneously irradiating both surfaces of the laminate with an electron beam. Therefore, the lead time can be further shortened (the productivity can be further improved). Therefore, the third production method is a particularly preferable production method.

Next, a preferred example of the production method of the packaging material according to the second invention will be described. The following fourth to sixth production methods can be exemplified.

(Fourth Production Method)

The fourth production method includes:

a step of creating a first laminate in which a heat fusible resin film 3 is bonded to one surface of a metal foil layer 4 via a second electron beam curable resin composition and then irradiating the first laminate with an electron beam from a side of the heat fusible resin film; and

a step of obtaining a second laminate by applying a third electron beam curable resin composition on the other surface of a metal foil layer 4 of a first laminate after irradiation of the electron beam, and then irradiating the second laminate with an electron beam from a side of the third electron beam curable resin composition.

(Fifth Production Method)

The fifth production method includes:

a step of obtaining a first laminate by applying a third electron beam curable resin composition on one surface of a metal foil layer 4, and then irradiating the first laminate with an electron beam from a side of a third electron beam curable resin composition; and

a step of creating a second laminate in which a heat fusible resin film 3 is bonded to the other surface of the metal foil layer 4 of the first laminate after irradiation of the electron beam via a second electron beam curable resin composition and then irradiating the second laminate with an electron beam from a side of the heat fusible resin film.

(Sixth Production Method)

The sixth production method includes:

a step of creating a first laminate in which a heat fusible resin film 3 is bonded to one surface of a metal foil layer 4 via a second electron beam curable resin composition;

a step of obtaining a second laminate by applying a third electron beam curable resin composition to the other surface of the metal foil layer 4 in the first laminate; and

a step of irradiating both surfaces of the second laminate with an electron beam.

Among these fourth to sixth manufacturing methods, in the sixth production method, simultaneous curing of the two layers (the base layer and the inner adhesive layer) can be carried out by simultaneously irradiating both surfaces of the second laminate with an electron beam. Therefore, there is a merit that the lead time can be further shortened. Therefore, the sixth production method is a particularly preferable production method.

In the first to sixth production methods, as the electron beam, ultraviolet light, visible light, X-ray, and γ-ray can be exemplified. In the case of irradiating the ultraviolet light or the visible light, the irradiation light amount is not particularly limited, but is preferably set to 50 mJ/cm² to 1,000 mJ/cm² per one side.

Further, in the fourth to sixth production methods, as a method for applying the third electron beam curable resin composition to the metal foil layer 4, although not particularly limited, a gravure roll coating method, a screen coating method, a coating method using an inkjet method, and a die coating method are exemplified. It is preferable to select the optimum coating method according to the material to be coated (third electron beam curable resin composition).

The above-described production methods are mere preferable examples, and the packaging material 1 of the present invention is not limited to the one produced by the above-described production method.

### Example

Next, specific examples of the present invention will be described, but the present invention is not particularly limited to those of these examples.

### Example 1

A chemical conversion coating film was formed by applying a chemical conversion treatment solution comprising a phosphoric acid, a polyacrylic acid (acryl based resin), a chromium (III) salt compound, water, alcohol on both sides of 35 μm thick aluminum foil 4 (aluminum foil of A8079 specified in JIS H4160), and thereafter drying it at 180° C. The chromium adhesion amount of this chemical conversion coating film was 10 mg/m² per one side.

Next, a light curing resin composition (outer adhesive) containing 98.8 parts by mass of urethane acrylate oligomer having two acryloyl groups (polymerizable oligomer), 0.2 parts by mass of pentaerythritol triacrylate (polymerizable monomer), and 1.0 parts by mass of benzophenone (photo-radical polymerization initiator) was applied on one surface of the chemical conversion treated aluminum foil 4 so that the mass after drying became 4 g/m².

A biaxially stretched nylon film (base layer) 2 having a hot water shrinkage percentage of 5.0% and a thickness of 15 μm was superimposed on the outer adhesive agent coated surface of one surface of the aluminum foil 4 and bonded to obtain a first laminate. The biaxially stretched nylon film having the hot water shrinkage percentage of 5.0% was obtained by setting the heat setting temperature at 191° C. when biaxially stretching the nylon film.

Next, on the other surface of the aluminum foil 4 in the first laminate, the same light curing resin composition as the light curing resin composition (outer adhesive agent) as an inner adhesive agent was applied so that the mass after drying became 4 g/m². Thereafter, a non-stretched polypropylene film 3 having a thickness of 30 μm was bonded to the inner side adhesive agent application surface to obtain a second laminate.

Then, both surfaces of the second laminate were simultaneously irradiated with ultraviolet rays of 300 mJ/cm² to light-cure the outer adhesive agent to form an outer adhesive layer (light cured film) 5 and light-cure the inner adhesive agent to form an inner adhesive layer (light cured film) 6. Thus, a packaging material for a power storage device 1 having the structure shown in FIG. 1 was obtained.

### Example 2

A packaging material 1 for a power storage device having the structure shown in FIG. 1 was obtained except that as an outer adhesive agent and an inner adhesive agent, a light curing resin composition containing 98.0 parts by mass of urethane acrylate oligomer having two acryloyl groups (polymerizable oligomer), 1.0 part by mass of pentaerythritol triacrylate (polymerizable monomer), and 1.0 part by mass of benzophenone was used.

### Example 3

A packaging material 1 for a power storage device shown in FIG. 1 was obtained in the same manner as in Example 1 except that as an outer adhesive agent and an inner adhesive agent, a light curing resin composition containing 94.0 parts by mass of urethane acrylate oligomer having two acryloyl groups, 5.0 parts by mass of pentaerythritol triacrylate, and 1.0 parts by mass of benzophenone was used.

### Example 4

A packaging material 1 for a power storage device shown in FIG. 1 was obtained in the same manner as in Example 1 except that as an outer adhesive agent and an inner adhesive agent, a light curing resin composition containing 94.0 parts by mass of urethane acrylate oligomer having two acryloyl groups, 1.0 parts by mass of pentaerythritol triacrylate, and 5.0 parts by mass of benzophenone was used.

### Example 5

A packaging material 1 for a power storage device shown in FIG. 1 was obtained in the same manner as in Example 1 except that as an outer adhesive agent and an inner adhesive agent, a light curing resin composition containing 90.0 parts by mass of urethane acrylate oligomer having two acryloyl groups, 1.0 parts by mass of pentaerythritol triacrylate, and 9.0 parts by mass of benzophenone was used.

### Example 6

A packaging material 1 for a power storage device shown in FIG. 1 was obtained in the same manner as in Example 2 except that in place of the biaxially stretched nylon film having the hot water shrinkage percentage of 5.0% and the thickness of 15 μm, a biaxially stretched nylon film having a hot water shrinkage percentage of 2.0% and a thickness of 15 μm was used. Note that the biaxially stretched nylon film having the hot water shrinkage percentage of 2.0% was obtained by setting the heat setting temperature at 214° C. when biaxially stretching the nylon film.

### Example 7

A packaging material 1 for a power storage device shown in FIG. 1 was obtained in the same manner as in Example 2 except that in place of the biaxially stretched nylon film having the hot water shrinkage percentage of 5.0% and the thickness of 15 μm, a biaxially stretched nylon film having a hot water shrinkage percentage of 10.0% and a thickness of 15 μm was used. Note that the biaxially stretched nylon film having the hot water shrinkage percentage of 10.0% was obtained by setting the heat setting temperature at 160° C. when biaxially stretching the nylon film.

### Example 8

A packaging material 1 for a power storage device shown in FIG. 1 was obtained in the same manner as in Example 1 except that as the outer adhesive agent and the inner adhesive agent, a light curing resin composition (not containing a polymerizable monomer) containing 97.0 parts by mass of urethane acrylate oligomer having two acryloyl groups and 3.0 parts by mass of benzophenone was used.

### Example 9

A packaging material 1 for a power storage device shown in FIG. 1 was obtained in the same manner as in Example 1 except that as the outer adhesive agent and the inner adhesive agent, a light curing resin composition containing 89.0 parts by mass of urethane acrylate oligomer having two acryloyl groups, 8.0 parts by mass of pentaerythritol triacrylate, and 3.0 parts by mass of benzophenone was used.

### Example 10

A packaging material 1 for a power storage device shown in FIG. 1 was obtained in the same manner as in Example 2 except that in place of the biaxially stretched nylon film having the hot water shrinkage percentage of 5.0% and the thickness of 15 μm, a biaxially stretched nylon film having a hot water shrinkage percentage of 0.5% and a thickness of 15 μm was used. Note that the biaxially stretched nylon film having the hot water shrinkage percentage of 0.5% was obtained by setting the heat setting temperature at 225° C. when biaxially stretching the nylon film.

### Example 11

A packaging material 1 for a power storage device shown in FIG. 1 was obtained in the same manner as in Example 2 except that in place of the biaxially stretched nylon film having the hot water shrinkage percentage of 5.0% and the thickness of 15 μm, a biaxially stretched nylon film having a hot water shrinkage percentage of 13.0% and a thickness of 15 μm was used. Note that the biaxially stretched nylon film having the hot water shrinkage percentage of 13.0% was obtained by setting the heat setting temperature at 131° C. when biaxially stretching the nylon film.

### Example 12

A packaging material 1 for a power storage device shown in FIG. 1 was obtained in the same manner as in Example 1 except that as the outer adhesive agent and the inner adhesive agent, a light curing resin composition containing 96.0 parts by mass of vinyl ether oligomer having two vinyl groups (polymerizable oligomer), 3.0 parts by mass of 2-hydroxyethyl vinyl ether (polymerizable monomer), and 1.0 part by mass of triphenylsulfonium hexafluorophosphate (sulfonium salt V; photo-cationic polymerization initiator).

### Comparative Example 1

A packaging material 1 for a power storage device shown in FIG. 1 was obtained in the same manner as in Example 1 except that as the outer adhesive agent and the inner adhesive agent, a light curing resin composition containing 84.0 parts by mass of urethane acrylate oligomer having two acryloyl groups, 1.0 part by mass of pentaerythritol triacrylate, and 15.0 parts by mass of benzophenone was used.

### Example 13

A chemical conversion coating film was formed by applying a chemical conversion treatment solution comprising a phosphoric acid, a polyacrylic acid (acryl based resin), a chromium (III) salt compound, water, alcohol on both sides of 35 μm thick aluminum foil 4 (aluminum foil of A8079 specified in JIS H4160), and thereafter drying it at 180° C. The chromium adhesion amount of this chemical conversion coating film was 10 mg/m² per one side.

Next, alight curing resin composition (outer adhesive agent) containing 98.0 parts by mass of a urethane acrylate oligomer having two acryloyl groups, 1.0 part by mass of pentaerythritol triacrylate, and 1.0 parts by mass of benzophenone was applied on one surface of the chemical conversion treated aluminum foil 4 so that the mass after drying became 4 g/m².

A biaxially stretched nylon film (base layer) 2 having a hot water shrinkage percentage of 5.0% and a thickness of 15 μm was superimposed on the outer adhesive agent coated surface of one surface of the aluminum foil 4 and bonded and then the surface of the nylon film 2 was irradiated with ultraviolet rays of 300 mJ/cm² to light-cure the outer adhesive agent to thereby form an outer adhesive layer (light cured film) 5. Thus, a laminate was obtained. The biaxially stretched nylon film having the hot water shrinkage percentage of 5.0% was obtained by setting the heat setting temperature at 191° C. when biaxially stretching the nylon film.

Next, on the other surface of the aluminum foil 4 in the laminate, the same light curing resin composition as the light curing resin composition (outer adhesive agent) as an inner adhesive agent was applied so that the mass after drying became 4 g/m², and a non-stretched polypropylene film 3 having a thickness of 30 μm was bonded to the inner side adhesive agent coated surface. Thereafter, the surface of the polypropylene film 3 was irradiated with ultraviolet rays of 300 mJ/cm² to light-cure the inner adhesive agent to thereby form an inner adhesive layer (light cured film) 6. Thus, a packaging material 1 for a power storage device having the configuration shown in FIG. 1 was obtained.

### Example 14

A chemical conversion coating film was formed by applying a chemical conversion treatment solution comprising a phosphoric acid, a polyacrylic acid (acryl based resin), a chromium (III) salt compound, water, alcohol on both sides of 35 μm thick aluminum foil 4 (aluminum foil of A8079 specified in JIS H4160), and thereafter drying it at 180° C. The chromium adhesion amount of this chemical conversion coating film was 10 mg/m² per one side.

Next, alight curing resin composition containing 96.0 parts by mass of a urethane acrylate oligomer having two acryloyl groups, 3.0 parts by mass of pentaerythritol triacrylate, and 1.0 part by mass of benzophenone was applied on one surface of the chemical conversion treated aluminum foil 4 so that the mass after drying became 4 g/m². A non-stretched polypropylene film 3 having a thickness of 30 μm was bonded to the inner side adhesive agent coated surface to obtain a first laminate.

Next, on the other surface of the aluminum foil 4 of the first laminate, the light curing resin composition (composition for forming a base layer) same as the aforementioned light curing resin composition (inner adhesive agent) was applied so that the mass after drying became 20.0 g/m².

Then, both surfaces of the second laminate were simultaneously irradiated with ultraviolet rays of 300 mJ/cm² to light-cure the inner adhesive agent to thereby form an inner adhesive layer (light cured film) 6 and light-cure the light curing resin composition for forming the base layer to form a base layer (light cured film) 2. Thus, a packaging material 1 for a power storage device having the structure shown in FIG. 2 was obtained.

### Example 15

A chemical conversion coating film was formed by applying a chemical conversion treatment solution comprising a phosphoric acid, a polyacrylic acid (acryl based resin), a chromium (III) salt compound, water, alcohol on both sides of 35 μm thick aluminum foil 4 (aluminum foil of A8079 specified in JIS H4160), and thereafter drying it at 180° C. The chromium adhesion amount of this chemical conversion coating film was 10 mg/m² per one side.

Next, a light curing resin composition (composition for forming a base layer) containing 96.0 parts by mass of a urethane acrylate oligomer having two aryloyl groups, 3.0 parts by mass of pentaerythritol triacrylate, and 1.0 part by mass of benzophenone was applied on one surface of the chemical conversion treated aluminum foil 4 so that the mass after drying became 20.0 g/m².

Next, the first laminate was irradiated with ultraviolet rays of 300 mJ/cm² from the coating surface side of the light curing resin composition to light-cure the light curing resin composition for forming the base layer to thereby form a base layer (light cured film) 2 on one surface of the aluminum foil 4.

Next, the same light curing resin composition as the light curing resin composition (composition for forming a base layer) as an inner adhesive agent was applied on the other surface of the aluminum foil 4 of the first laminate after being irradiated with ultraviolet rays so that the mass after drying became 4 g/m². Thereafter, a non-stretched polypropylene film 3 having a thickness of 30 μm was bonded to the inner side adhesive agent coated surface to obtain a second laminate. The second laminate was irradiated with ultraviolet rays of 300 mJ/cm² from the non-stretched polypropylene film side to light-cure the inner adhesive agent to thereby form an inner adhesive layer (light cured film) 6. Thus, a packaging material 1 for a power storage device 1 having the configuration shown in FIG. 2 was obtained.

### Example 16

A chemical conversion coating film was formed by applying a chemical conversion treatment solution comprising a phosphoric acid, a polyacrylic acid (acryl based resin), a chromium (III) salt compound, water, alcohol on both sides of 35 μm thick aluminum foil 4 (aluminum foil of A8079 specified in JIS H4160), and thereafter drying it at 180° C. The chromium adhesion amount of this chemical conversion coating film was 10 mg/m² per one side.

Next, a light curing resin composition containing 96.0 parts by mass of a urethane acrylate oligomer having two acryloyl groups, 3.0 parts by mass of pentaerythritol triacrylate, and 1.0 part by mass of benzophenone was applied on one surface of the chemical conversion treated aluminum foil 4 so that the mass after drying became 4 g/m². A non-stretched polypropylene film 3 having a thickness of 30 μm was bonded to the inner side adhesive agent coated surface to obtain a first laminate. The first laminate was irradiated with ultraviolet rays of 300 mJ/cm² from the polypropylene film 3 side to light-cure the inner adhesive agent to therefore form an inner adhesive layer (light cured film) 6.

Next, the same light curing resin composition as the light curing resin composition (composition for forming a base layer) as the light curing resin composition (inner adhesive agent) was applied on the other surface of the aluminum foil 4 of the first laminate after irradiation of the electron beam so that the mass after drying became 20.0 g/m² to obtain a second laminate. The second laminate was irradiated with ultraviolet rays of 300 mJ/cm² from the coated side of the composition for forming the base layer to light-cure the light curing resin composition for forming the base layer to thereby form a base layer (light cured film) 2. Thus, a packaging material 1 for a power storage device having the configuration shown in FIG. 2 was obtained.

### Comparative Example 2

A chemical conversion coating film was formed by applying a chemical conversion treatment solution comprising a phosphoric acid, a polyacrylic acid (acryl based resin), a chromium (III) salt compound, water, alcohol on both sides of 35 μm thick aluminum foil 4 (aluminum foil of A8079 specified in JIS H4160), and thereafter drying it at 180° C. The chromium adhesion amount of this chemical conversion coating film was 10 mg/m² per one side.

Next, alight curing resin composition containing 96.0 parts by mass of a urethane acrylate oligomer having two acryloyl groups, 3.0 parts by mass of pentaerythritol triacrylate, and 1.0 parts by mass of benzophenone was applied on one surface of the chemical conversion treated aluminum foil 4 so that the mass after drying became 4 g/m². Thereafter, a non-stretched polypropylene film 3 having a thickness of 30 μm was bonded to the inner side adhesive agent coated surface to obtain a laminate.

Next, the surface of the polypropylene film 3 of the laminate was irradiated with ultraviolet rays of 300 mJ/cm² to light-cure the inner adhesive agent to thereby form an inner adhesive layer (light cured film) 6. Thus, a packaging material for a power storage device having a three-layer configuration not having both an outer adhesive agent and a base layer was obtained.

### Reference Example

A chemical conversion coating film was formed by applying a chemical conversion treatment solution comprising a phosphoric acid, a polyacrylic acid (acryl based resin), a chromium (III) salt compound, water, alcohol on both surfaces of 35 μm thick aluminum foil (aluminum foil of A8079 specified in JIS H4160), and thereafter drying it at 180° C. Thus, a chemical conversion coating film was formed. The chromium adhesion amount of this chemical conversion coating film was 10 mg/m² per one side.

Next, a urethane based adhesive agent (outer adhesive agent) was applied to one surface of the aluminum chemical conversion treated aluminum foil so that the mass after drying was 4.0 g/m², and then a biaxially stretched nylon film having a hot water shrinkage percentage of 5.0% and a thickness of 15 μm was superimposed on the outer side adhesive agent coated surface to obtain a first laminate. Note that he biaxially stretched nylon film having the hot water shrinkage percentage of 5.0% was obtained by setting the heat setting temperature at 191° C. when biaxially stretching the nylon film. The first laminate was allowed to stand for 7 days in an environment of 60° C. and subjected to a heat aging treatment to cure the outer adhesive agent to thereby form an outer adhesive layer.

Next, an inner adhesive agent composed of a heat curing type acid-modified polypropylene adhesive agent was applied on the other surface of the aluminum foil of the first laminate so that the mass after drying became 2.0 g/m². Thereafter, a non-stretched polypropylene film having a thickness of 30 μm was bonded to the inner side adhesive agent coated surface to obtain a second laminate.

The second laminate was subjected to a heat aging treatment by leaving to stand in an environment of 40° C. for 7 days to cure the inner adhesive agent to thereby form the inner adhesive layer. Thus, a packaging material for a power storage device was obtained.

TABLE 1

| | | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|
| Light curable | A | Urethane | 98.8 | 98.0 | 94.0 | 94.0 | 90.0 | 98.0 | 98.0 | 97.0 | 89.0 |
| resin | | acrylate | | | | | | | | | |
| composition | | oligomer | | | | | | | | | |
| (parts by mass) | | Vinyl ether | — | — | — | — | — | — | — | — | — |
| | | oligomer | | | | | | | | | |
| | B | Acrylate monomer | 0.2 | 1.0 | 5.0 | 1.0 | 1.0 | 1.0 | 1.0 | — | 8.0 |
| | | Vinyl ether | — | — | — | — | — | — | — | — | — |
| | | monomer | | | | | | | | | |
| | C | Benzophenone | 1.0 | 1.0 | 1.0 | 5.0 | 9.0 | 1.0 | 1.0 | 3.0 | 3.0 |
| | | Sulfonium salt V | — | — | — | — | — | — | — | — | — |

| Material of base layer | | Nylon | Nylon | Nylon | Nylon | Nylon | Nylon | Nylon | Nylon | Nylon |
|---|---|---|---|---|---|---|---|---|---|---|
| Hot water shrinkage percentage of the | | 5.0 | 5.0 | 5.0 | 5.0 | 5.0 | 2.0 | 10.0 | 5.0 | 5.0 |
| base layer (%) | | | | | | | | | | |
| Evaluation | Laminate strength | 5.1 | 5.5 | 5.4 | 5.3 | 5.2 | 5.5 | 5.6 | 3.4 | 4.9 |
| | (N/15 mm width) | | | | | | | | | |
| | Maximum forming depth | 6.0 | 6.5 | 6.5 | 5.5 | 5.5 | 5.0 | 7.0 | 5.5 | 5.5 |
| | (mm) | | | | | | | | | |
| | Puncture strength (N) | 15.2 | 15.3 | 15.2 | 15.1 | 15.2 | 15.2 | 15.3 | 15.1 | 15.3 |
| | Sealability | ◯ | ◯ | ◯ | ◯ | ◯ | ◯ | ◯ | ◯ | ◯ |

TABLE 2

| | | | Ex. 10 | Ex. 11 | Ex. 12 | Comp. Ex. 1 | Ex. 13 | Ref. Ex. |
|---|---|---|---|---|---|---|---|---|
| Light curable resin | A | Urethane acrylate | 98.0 | 98.0 | — | 84.0 | 98.0 | |
| composition (parts | | oligomer | | | | | | |
| by mass) | | Vinyl ether | — | — | 96.0 | — | — | |
| | | oligomer | | | | | | |
| | B | Acrylate monomer | 1.0 | 1.0 | — | 1.0 | 1.0 | |
| | | Vinyl ether | — | — | 3.0 | — | — | |
| | | monomer | | | | | | |
| | C | Benzophenone | 1.0 | 1.0 | — | 15.0 | 1.0 | |
| | | Sulfonium salt V | — | — | 1.0 | — | — | |

| | | | | | | | |
|---|---|---|---|---|---|---|---|
| | Material of base layer | Nylon | Nylon | Nylon | Nylon | Nylon | Nylon |
| | Hot water shrinkage | 0.5 | 13.0 | 5.0 | 5.0 | 5.0 | 5.0 |
| | percentage of the base | | | | | | |
| | layer (%) | | | | | | |
| Evaluation | Laminate strength | 5.3 | 5.2 | 5.3 | 1.7 | 5.3 | 5.3 |
| | (N/15 mm width) | | | | | | |
| | Maximum forming depth | 4.0 | 7.0 | 6.0 | 5.5 | 6.0 | 5.0 |
| | (mm) | | | | | | |
| | Puncture strength (N) | 15.2 | 15.1 | 15.5 | 15.1 | 15.3 | 15.1 |
| | Sealability | ◯ | Δ | ◯ | X | ◯ | ◯ |

TABLE 3

| | | | Ex. 14 | Ex. 15 | Ex. 16 | Comp. Ex. 2 |
|---|---|---|---|---|---|---|
| Light curable | A | Urethane acrylate | 96.0 | 96.0 | 96.0 | |
| resin composition | | oligomer | | | | |
| (parts by mass) | | Vinyl ether oligomer | — | — | — | |
| | B | Acrylate monomer | 3.0 | 3.0 | 3.0 | |
| | | Vinyl ether monomer | — | — | — | |
| | C | Benzophenone | 1.0 | 1.0 | 1.0 | |
| | | Sulfonium salt V | — | — | — | |
| | | Material of base layer | Cured film of | Cured film of | Cured film of | Nil |
| | | | the above | the above | the above | |
| | | | composition | composition | composition | |
| | | Hot water shrinkage | — | — | — | — |
| | | percentage of the base | | | | |
| | | layer (%) | | | | |
| Evaluation | | Laminate strength | — | — | — | — |
| | | (N/15 mm width) | | | | |
| | | Maximum forming | 5.5 | 5.0 | 6.0 | 2.0 |
| | | depth (mm) | | | | |
| | | Puncture strength (N) | 15.2 | 15.1 | 15.1 | 10.3 |
| | | Sealability | ◯ | ◯ | ◯ | — |

In Tables 1 to 3, triphenylsulfonium hexafluorophosphate is denoted as “sulfonium salt V”. In Tables 1 to 3, “A” denotes a polymerizable oligomer, “B” denotes a polymerizable monomer, “C” denotes an electron beam polymerization initiator in the light curing resin composition column.

Evaluation was performed on each external material (packaging material) for a power storage device obtained as described above based on the following measuring method and evaluation method.

<Method of Measuring Lamination Strength at High Temperature>

A specimen having a width of 15 mm and a length of 150 mm was cut out from the obtained packaging material, and separated between the aluminum foil and the base layer in the region from the one end in the longitudinal direction to the position inside 10 mm inward of this test specimen.

According to JIS K6854-3 (1999), using a strograph (AGS-5kNX) manufactured by Shimadzu Corporation, the laminate containing an aluminum foil was clamped and fixed with one of chucks, and the separated base layer was clamped and fixed with the other chuck. After leaving to hold for 1 minute under a temperature environment of 120° C., the separation strength was measured as it was when it was separated in T-type at a tensile rate of 100 mm/min under a temperature environment of 120° C. The value at which this measured value stabilized was taken as “lamination strength (N/15 mm width) at high temperature”. The sample having a lamination strength of “2.0 N/15 mm width” or more were evaluated as “Passed”.

<Formability (Maximum Forming Depth) Evaluation Method>

Using a deep-drawing forming tool manufactured by Amada Corporation, deep-drawing forming was carried out on a packaging material into a substantially rectangular parallelepiped shape (55 mm long×35 mm wide×deep) (a substantially rectangular parallelepiped shape with one opened surface). That is, deep-drawing forming was carried out by changing the forming depth by 0.5 mm unit. Then, the presence or absence of pinholes and/or cracks at the corner portion of the obtained molded body was investigated, and the “maximum forming depth (mm)” in which such pinholes and cracks did not occur was investigated. The presence or absence of pinholes and/or cracks was examined by a light transmission method in a dark room. The sample having a maximum forming depth of 3.5 mm or more was evaluated as “Passed”.

<Evaluation Method of Sealing Property>

(Evaluation of Presence or Absence of Occurrence of Delamination when Forming with Deep Forming Depth was Performed)

As forming with a deep forming depth, a deep-drawing forming was carried out on the packaging material having a substantially rectangular parallelepiped shape (substantially rectangular parallelepiped shape with one surface opened) of 55 mm long×35 mm width×5.5 mm depth. At this time, shaping was carried out so that the base layer 2 was located outside the shaped body. For each Example and each Comparative Example, two formed products were produced. The flange portions (sealing peripheral portion: see FIG. 4) 29 of two formed products (shaped case) 10 were brought into contact with each other and heat sealed at 170° C. for 6 seconds. Then, by visual observation, the presence or absence of occurrence of delamination (separation) in the heat seal portion 39 and the presence or absence of floating of the appearance were examined and evaluated based on the following criteria.

### (Criteria)

“O”: No delamination (separation) was observed and no floating appearance was observed (Passed)
“Δ”: Although slight delamination (separation) occurred in rare cases, there was substantially no delamination (separation) and there was substantially no floating appearance (Passed)
“X”: Delamination (separation) was observed and floating appearance was observed (Failed)

<Puncture Strength Measurement Method>

A specimen with a width of 15 mm and a length of 150 mm was cut out from the obtained packaging material and the puncture strength (N) was measured in accordance with JIS Z1707-1997 using an Autograph (AGS-X) manufactured by Shimadzu Corporation. Measurement was carried out by setting the measurement needle so as to contact the surface of the outer layer at the center position (width center position) of 15 mm width of the test specimen. Those having puncture strength of 12 N or more were denoted as “Passed”.

As is clear from the tables, in the packaging material (packaging material for a power storage device) of Examples 1 to 16 of the present invention, the inner adhesive agent and the outer adhesive agent or base layer are formed by electron beam curing of the electron beam curable resin composition. Therefore, the lead time can be greatly shortened and therefore the productivity can be improved. Further, even if forming with a deep forming depth is performed, neither pinholes nor cracks occur and excellent formability is provided, and even if forming with a deep forming depth is performed, delamination (separation) can be suppressed.

On the other hand, in Comparative Example 1 deviating from the scope of the claims of the present invention, sufficient lamination strength was not obtained, and delamination occurred when carrying out forming with a deep forming depth. Further, in Comparative Example 2, the maximum forming depth was 2.0 mm, which was inferior to the formability, and sufficient puncture strength could not be obtained.

### INDUSTRIAL APPLICABILITY

The packaging material according to the present invention is preferably used as a packaging material (packaging material for a power storage device) for various power storage devices, such as, e.g., a power storage device such as lithium secondary batteries (lithium ion batteries, lithium polymer batteries, etc.), lithium-ion capacitors, and electric double layer capacitors. Further, the packaging material according to the present invention can be used as a packaging material for foods, a packaging material for pharmaceutical products, and the like.

The present application claims priority to Japanese Patent Application No. 2016-191343 filed on Sep. 29, 2016, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention. The present invention allows any design changes unless departing from its spirit within the scope of the claims.

### DESCRIPTION OF REFERENCE SYMBOLS

1: packaging material
2: base layer (outer layer)
3: heat fusible resin layer (inner layer)
4: metal foil layer
5: outer adhesive layer (first adhesive layer)
6: inner adhesive layer (second adhesive layer)

1. A packaging material for a power storage device, comprising:
a base layer as an outer layer;
a heat fusible resin layer as an inner layer; and
a metal foil layer arranged between the base layer and the heat fusible resin layer,
wherein the base layer and the metal foil layer are bonded via an outer adhesive layer composed of a cured film of a first electron beam, ultraviolet light, visible light, X-ray or γ-ray curable resin composition containing an electron beam, ultraviolet light, visible light, X-ray or γ-ray polymerization initiator,
wherein the heat fusible rein layer and the metal foil layer are bonded via an inner adhesive layer composed of a cured film of a second electron beam, ultraviolet light, visible light, X-ray or γ-ray curable resin composition containing an electron beam, ultraviolet light, visible light, X-ray or γ-ray polymerization initiator,
wherein a content rate of the electron beam, ultraviolet light, visible light, X-ray or γ-ray polymerization initiator in the first electron beam, ultraviolet light, visible light, X-ray or γ-ray curable resin composition is 0.1 mass % to 10 mass %, and
wherein a content rate of the electron beam, ultraviolet light, visible light, X-ray or γ-ray polymerization initiator in the second electron beam, ultraviolet light, visible light, X-ray or γ-ray curable resin composition is 0.1 mass % to 10 mass %.

2. The packaging material as recited in claim 1,
wherein the first electron beam, ultraviolet light, visible light, X-ray or γ-ray curable resin composition and the second electron beam, ultraviolet light, visible light, X-ray or γ-ray curable resin composition each are a composition containing a polymerizable oligomer and a polymerizable monomer together with the electron beam, ultraviolet light, visible light, X-ray or γ-ray polymerization initiator, and
wherein the content rate of the polymerizable monomer in each of the first electron beam, ultraviolet light, visible light, X-ray or γ-ray curable resin composition and the second electron beam, ultraviolet light, visible light, X-ray or γ-ray curable resin composition is 0.01 mass % to 5 mass %.

3. The packaging material as recited in claim 1,
wherein the second electron beam, ultraviolet light, visible light, X-ray or γ-ray curable resin composition has the same composition as the first electron beam, ultraviolet light, visible light, X-ray or γ-ray curable resin composition.

4. The packaging material as recited in claim 1,
wherein the base layer is composed of a heat resistant resin film having a hot water shrinkage percentage of 1.5% to 12%.

5. A packaging material comprising:
a base layer as an outer layer;
a heat fusible resin layer as an inner layer; and
a metal foil layer arranged between the base layer and the heat fusible resin layer,
wherein the base layer is composed of a cured film of a third electron beam, ultraviolet light, visible light, X-ray or γ-ray curable resin composition containing an electron beam, ultraviolet light, visible light, X-ray or γ-ray polymerization initiator,
wherein the heat fusible rein layer and the metal foil layer are bonded via an inner adhesive layer composed of a cured film of a second electron beam, ultraviolet light, visible light, X-ray or γ-ray curable resin composition containing an electron beam, ultraviolet light, visible light, X-ray or γ-ray polymerization initiator,
wherein a content rate of the electron beam, ultraviolet light, visible light, X-ray or γ-ray polymerization initiator in the second electron beam, ultraviolet light, visible light, X-ray or γ-ray curable resin composition is 0.1 mass % to 10 mass %, and
wherein a content rate of the electron beam, ultraviolet light, visible light, X-ray or γ-ray polymerization initiator in the third electron beam, ultraviolet light, visible light, X-ray or γ-ray curable resin composition is 0.1 mass % to 10 mass %.

6. The packaging material as recited in claim 5,
wherein the third electron beam, ultraviolet light, visible light, X-ray or γ-ray curable resin composition has the same composition as the second electron beam, ultraviolet light, visible light, X-ray or γ-ray curable resin composition.

7. A method of producing a packaging material, comprising:
a step of preparing a first laminate in which a resin film for a base layer is bonded to one surface of a metal foil layer via a first electron beam, ultraviolet light, visible light, X-ray or γ-ray curable resin composition and then irradiating the first laminate with an electron beam, ultraviolet light, visible light, X-ray or γ-ray from a side of the resin film for a base layer; and
a step of preparing a second laminate in which a heat fusible resin film is bonded to the other surface of the metal foil layer of the first laminate after irradiation of the electron beam, ultraviolet light, visible light, X-ray or γ-ray via a second electron beam, ultraviolet light, visible light, X-ray or γ-ray curable resin composition and then irradiating the second laminate with an electron beam, ultraviolet light, visible light, X-ray or γ-ray from a side of the heat fusible resin film.

8. A method of producing a packaging material, comprising:
a step of preparing a first laminate in which a heat fusible resin film is bonded to one surface of a metal foil layer via a second electron beam, ultraviolet light, visible light, X-ray or γ-ray curable resin composition and then irradiating the first laminate with an electron beam, ultraviolet light, visible light, X-ray or γ-ray from a side of the heat fusible resin film; and
a step of preparing a second laminate in which a resin film for a base layer is bonded to the other surface of the metal foil layer of the first laminate after irradiation of the electron beam, ultraviolet light, visible light, X-ray or γ-ray via a first electron beam, ultraviolet light, visible light, X-ray or γ-ray curable resin composition and then irradiating the second laminate with an electron beam, ultraviolet light, visible light, X-ray or γ-ray from a side of the resin film for a base layer.

9. A method of producing a packaging material, comprising:
a step of preparing a laminate in which a resin film for a base layer is bonded to one surface of a metal foil layer via a first electron beam, ultraviolet light, visible light, X-ray or γ-ray curable resin composition and a heat fusible resin film is bonded to the other surface of the metal foil layer via a second electron beam, ultraviolet light, visible light, X-ray or γ-ray curable resin composition; and
a step of irradiating both surfaces of the laminate with an electron beam, ultraviolet light, visible light, X-ray or γ-ray.

10. A method of producing a packaging material, comprising:
a step of preparing a first laminate in which a heat fusible resin film is bonded to one surface of a metal foil layer via a second electron beam, ultraviolet light, visible light, X-ray or γ-ray curable resin composition and then irradiating the first laminate with an electron beam, ultraviolet light, visible light, X-ray or γ-ray from a side of the heat fusible resin film; and
a step of obtaining a second laminate by applying a third electron beam, ultraviolet light, visible light, X-ray or γ-ray curable resin composition on the other surface of a metal foil layer of a first laminate after irradiation of the electron beam, ultraviolet light, visible light, X-ray or γ-ray, and then irradiating the second laminate with an electron beam, ultraviolet light, visible light, X-ray or γ-ray from a side of the third electron beam, ultraviolet light, visible light, X-ray or γ-ray curable resin composition.

11. A method of producing a packaging material, comprising:
a step of obtaining a first laminate by applying a third electron beam, ultraviolet light, visible light, X-ray or γ-ray curable resin composition on one surface of a metal foil layer, and then irradiating the first laminate with an electron beam, ultraviolet light, visible light, X-ray or γ-ray from a side of the third electron beam, ultraviolet light, visible light, X-ray or γ-ray curable resin composition; and
a step of preparing a second laminate in which a heat fusible resin film is bonded to the other surface of the metal foil layer of the first laminate after irradiation of the electron beam, ultraviolet light, visible light, X-ray or γ-ray via a second electron beam, ultraviolet light, visible light, X-ray or γ-ray curable resin composition and then irradiating the second laminate with an electron beam, ultraviolet light, visible light, X-ray or γ-ray from a side of the heat fusible resin film.

12. A method of producing a packaging material, comprising:
a step of preparing a first laminate in which a heat fusible resin film is bonded to one surface of a metal foil layer via a second electron beam, ultraviolet light, visible light, X-ray or γ-ray curable resin composition;
a step of obtaining a second laminate by applying a third electron beam, ultraviolet light, visible light, X-ray or γ-ray curable resin composition to the other surface of the metal foil layer in the first laminate; and
a step of irradiating both surfaces of the second laminate with an electron beam, ultraviolet light, visible light, X-ray or γ-ray.
